(19) United States
(12) Patent Application Publication
(10) Pub. No.: US 2011/0099163 A1
(43) Pub. Date: Apr. 28, 2011

(54) SYSTEM AND METHOD FOR INDEXING, ORGANIZING, STORING AND RETRIEVING ENVIRONMENTAL INFORMATION

(75) Inventors: Richard Harris, San Jose, CA (US); Eric Rosenblum, San Jose, CA (US)

(73) Assignee: ENVIROSPECTIVES CORPORATION, San Jose, CA (US)

(21) Appl. No.: 12/701,389

(22) Filed: Feb. 5, 2010

Related U.S. Application Data
(63) Continuation-in-part of application No. 11/058,752, filed on Feb. 14, 2005, now Pat. No. 7,685,105.
Application No. 11/058,752 is a continuation of application No. 10/117,361, filed on Apr. 5, 2002, now Pat. No. 6,856,907.

(51) Int. Cl. G06F 17/30

(52) U.S. Cl. 707/723; 707/769; 707/E17.014

(57) ABSTRACT

Embodiments of the present invention provide indexing, organizing, storing and/or retrieving of environmental information regarding a proposed environment-modifying project, including information about an environment-modifying natural event or construction project (“project”); a natural, constructed or socioeconomic feature in the area of the project (“setting”); a change to the setting brought about by the project (“impact”); or a feature designed to ameliorate a potential environmental impact of the project (“mitigation”). The environmental information is indexed with metadata that may be hierarchically organized and made available to a reviewer in a controlled vocabulary or a user-defined vocabulary.

### CROSS-REFERENCE TO RELATED APPLICATIONS

This patent application is a continuation-in-part of, and claims the benefit to both, U.S. patent application Ser. No. 10/117,361, filed Apr. 5, 2002, U.S. patent application Ser. No. 11/058,752, filed Feb. 14, 2005, and U.S. Provisional Patent Application 60/282,302, filed Apr. 5, 2001, which are hereby incorporated by reference in their entireties.

### BACKGROUND OF THE INVENTION

1. Field of the Invention

The present invention relates to an enhanced form of indexing, organizing, storing and retrieving environmental information.

2. Description of the Related Art

A barrier to the efficient retrieval of stored environmental information is the difficulty to index the information with terms that are both uniquely and intuitively related to specific, relevant aspects of the data. In general, the more unique an indexing term is, the less intuitive it is, and the less convenient it is to researchers conducting the search. Conversely, the more intuitive a search term is, the more likely it is to be confused with other common terms and the less likely it is to return a unique category of records. For instance, common keywords used to search environmental information may be ambiguous as when the term “salmon” returns records referring to the color “salmon” instead of the fish.

To address these and other problems and to help ensure that users searching environmental documents receive accurate results, it is therefore desirable to provide a system and method for indexing, organizing, storing and retrieving environmental information to facilitate improved searches.

### SUMMARY OF THE INVENTION

Embodiments of the present invention provide indexing, organizing, storing and/or retrieving of environmental information regarding a proposed environment-modifying project, including information about an environment-modifying natural event or construction project (“project”); a natural, constructed or socioeconomic feature in the area of the project (“setting”); a change to the setting brought about by the project (“impact”); or a feature designed to ameliorate a potential environmental impact of the project (“mitigation”).

Some embodiments of the present invention associate unique data records with one or more metadata terms from a controlled vocabulary (either preselected or user-specified) including environmental descriptors in a variety of useful categories (including but not limited to document properties, topic, location, date, and species).

Some embodiments of the present invention, construct a database associating one or more descriptive pre-formatted or user-specified metadata terms to any unique data record.

Some embodiments of the present invention, assign metadata terms to environmental data records by selecting a source document, text, tabular, graphic or other data from any source and subsequently selecting appropriate metadata terms or values from a previously developed menu of metadata descriptors.

Some embodiments of the present invention provide a menu of metadata terms, or values, to characterize a given source, or document, in response to the type of environmental information it contains.

Some embodiments of the present invention automatically assign appropriate metadata identifiers to characterize environmental information in a given source or document based on the frequency of their occurrence.

In some embodiments of the present invention, some of the metadata terms describe locations for which the value of the metadata is provided in terms of geographic coordinates (i.e. geocodes).

In some embodiments of the present invention, some of the metadata terms describe a time period related to the information for which the value of the metadata is provided in terms of a date or set of dates.

Some embodiments of the present invention retrieve information by specifying search terms from a controlled vocabulary, describing the desired data (metadata), and receiving a list of available data records prioritized according to the degree to which their metadata matches the entered search terms.

In some embodiments of the present invention, some of the environmental descriptors are hierarchically or thematically related to other descriptors in the controlled vocabulary of metadata to facilitate searches.

Some embodiments of the present invention locate indexed information by specifying search terms from a controlled metadata vocabulary and further specifying a type of relationship of associated metadata terms (e.g. “broad,” “narrow,” “used for” or “related”) and receiving a list of available data records prioritized according to the degree to which their metadata matches the metadata associated with the entered search terms.

In some embodiments of the present invention, additional vocabularies (thesauri) are related to the controlled metadata terms in a Metadata Database to increase the likelihood that a given search will produce useful results.

In some embodiments of the present invention, a thesaurus of common species names is related to a controlled vocabulary of scientific names.

In some embodiments of the present invention, a thesaurus of common and specific place names is related to a controlled vocabulary of geocodes.

Some embodiments of the present invention, locate indexed information by specifying search terms from a thesaurus associated with a controlled metadata vocabulary and receiving a list of available data records prioritized according to the degree to which their metadata matches the metadata associated with the entered search terms. For example, the list of available data records may be prioritized according to the frequency with which the search terms match the metadata terms or terms in the text itself.

Some embodiments of the present invention, locate non-indexed information by entering search terms and receiving a list of available data records prioritized according to the frequency with which the search terms match the metadata associated with the data records through some other means, or the terms match the terms contained within the text of the data record itself.

Some embodiments of the present invention are performed by software stored in processor readable memory of a processing device communicatively coupled to the Internet.

Some embodiments of the present invention locate information by entering search terms and receiving a list of available data records prioritized according to the frequency with which the search terms match the metadata associated with the data records through some other means, or the terms match the terms contained within the text of the data record itself and present additional information describing the results of the search in terms of the number of results retrieved, or the number of results retrieved that correspond to specific search terms, or a summary of the results received.

Some embodiments of the present invention display a list of available data records prioritized according to the relevance of the results as determined by the number of one or more search terms that match the metadata associated with those data records or the number of times one or more search terms occurs in the text of the data records or some combination of those parameters.

Some embodiments of the present invention store or retain a list of available data records received as a result of entering one or more search terms and receiving a list of available data records, and retrieve the retained list.

Some embodiments of the present invention retrieve a prior list of available data records received as a result of previously entering search terms and receiving a list of available data records, and display the parameters of the search with additional information describing the received results in terms of the number of results retrieved, or the number of results retrieved that correspond to specific search terms, or a summary of the results received.

Some embodiments of the present invention locate information by retrieving a retained list of available data records received as a result of previously entering search terms and receiving a list of available data records and executing a new search with the same parameters used in the retained search.

Some embodiments of the present invention locate information by retrieving a stored or retained list of available data records received as a result of previously entering search terms and receiving a list of available data records and executing a new search after modifying one or more of the parameters used in the retained search in order to form modified search terms.

Some embodiments of the present invention locate information by retrieving a stored or retained list of available data records received as a result of previously entering search terms and receiving a list of available data records and automatically executing a new search after a specified period of time or on a specific date.

These and other embodiments of the present invention, as well as other aspects and advantages are described in more detail in conjunction with the figures, the detailed description, and the claims that follow.

### BRIEF DESCRIPTION OF THE DRAWINGS

FIG. 1 is a block diagram structure of primary and secondary databases and user interface.

FIG. 2 is a flow chart of search using metadata or thesaurus search terms.

FIG. 3 is a flow chart of search including hierarchical metadata relationships.

FIG. 4 is a diagram example search schematic No. 1.

FIG. 5 is a diagram example broad and narrow term search schematic No. 2.

FIG. 6 is a diagram example search schematic No. 3.

FIG. 7 is a diagram example search term entry screen.

FIG. 8 is a diagram example search results (return) screen.

FIG. 9 is a diagram thesaurus structure showing hierarchical relationship between terms.

FIG. 10 is a diagram of screen shots showing substitution of metadata terms for thesaurus terms and selection of hierarchical relationship term.

FIG. 11 is a flowchart of metadata assignment tool.

FIG. 12 is a diagram example menu-driven metadata assignment screen shot No. 1.

FIG. 13 is a diagram example menu-driven metadata assignment screen shot No. 2.

FIG. 14 is a metadata assignment schematic.

FIG. 15 is a diagram example of a saved or retrieved search results screen showing search and results metadata and execution options.

FIG. 16 is a diagram example of a user interface providing options for a user to search within previously generated results.

FIG. 17 is a block diagram of a data processing system in accordance with an illustrative embodiment of the invention.

### DETAILED DESCRIPTION OF THE PREFERRED EMBODIMENT

Illustrative embodiments disclose a system and method for indexing, organizing, storing and retrieving information regarding a proposed environment-modifying project is provided in some embodiments of the present invention. A system and method for assigning metadata to environmental information, and a system and method for relating search terms to a controlled vocabulary of metadata are also provided in embodiments of the present information.

Accordingly, researchers can more accurately access environmental information that is indexed with preselected or user-defined metadata terms. Furthermore, information searches are more likely to result in the return of data records that meet researcher needs, as compared to current keyword searches, when search terms from a thesaurus of common terms are associated with metadata terms that can be searched according to hierarchical and thematic relationships.

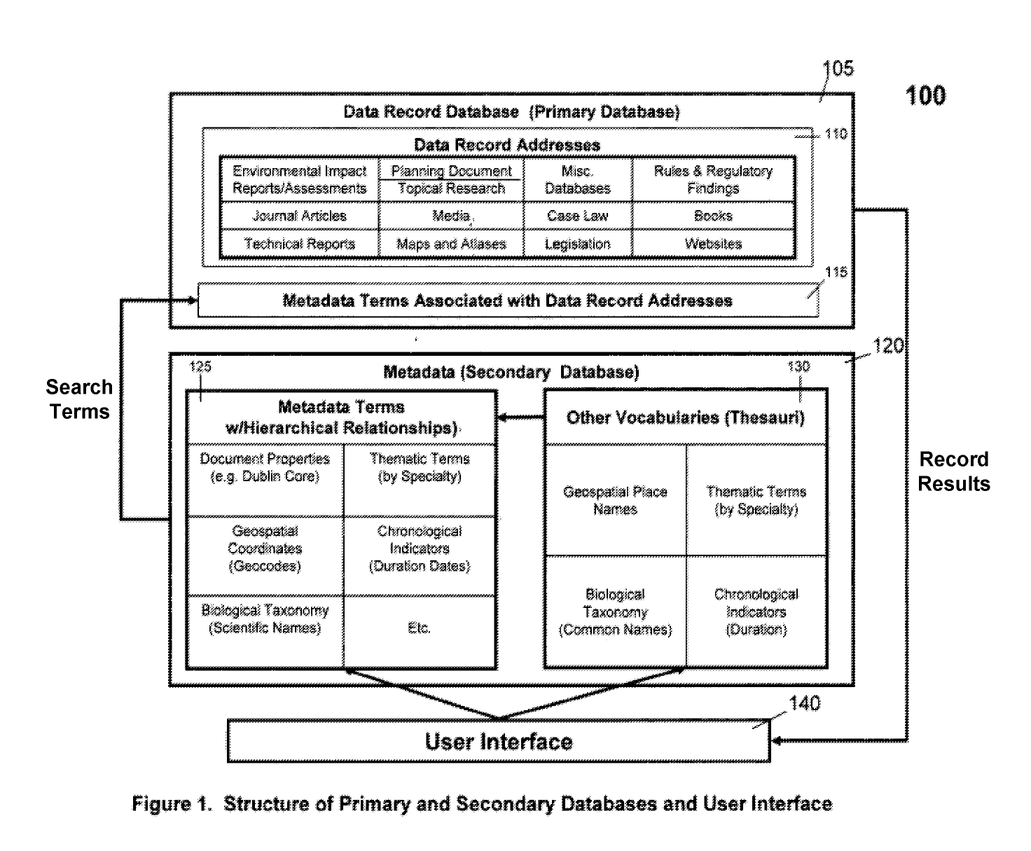

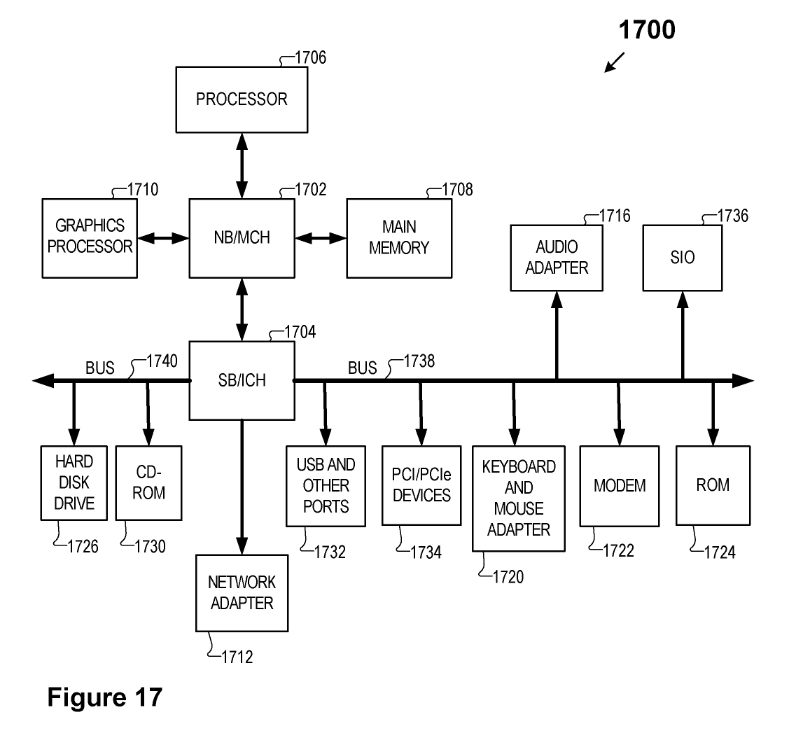

FIG. 1 illustrates the structure of the main components of the system and method for indexing, organizing, storing and retrieving information regarding a proposed environment-modifying project 100. The main components may be implemented by a data processing system, explained below in FIG. 17. The components can include: 1) a data record database (or primary database) 105 that includes an address or location of one or more pieces of electronic and non-electronic information 110, each associated with one or more terms from a controlled vocabulary of specific metadata terms 115 that uniquely characterize the form and content of the data records; 2) a metadata database (secondary database) 120 associating various metadata terms from a controlled vocabulary 125 with thesaurus terms from one or more thesauri (vocabularies) 130 to which they are equivalent; and 3) a user interface 135. The user interface may be implemented as computer instructions executing on a data processing system so that a user may enter search terms (either metadata terms or thesaurus terms) to query the primary database 105 and receive search results in the form of a list of data records with their addresses 110, and/or links to the data records.

As illustrated in FIG. 1, the database consists of the data record locations 110 for the various types of information, including but not limited to the following: Planning Documents; Environmental Impact Reports (EIRs); Journal Articles; Technical Reports; Topical Research; Media; Academic studies; Databases; Case Law; Legislation; Regulations and Regulatory Findings; Books; Websites; Maps and Atlases.

Data records may include electronic or non-electronic information. Electronic data records can be resident at a variety of locations, including storage on a single computer or on a server accessible through a private network, or on a website accessible through the internet. Non-electronic data records may be located at a public or private library or at a public or private office, access to which may be open or restricted. The computer, website, and other processor dependent devices, may be one or more data processing systems as described in FIG. 17, explained further below.

The data record database 105 contains information sufficient to specify a unique location of each data record (“address”) 110 such that the return of a data record's address 110 is sufficient to allow the user to locate the data record. In the case of electronic data, in some embodiments the address 110 is formatted in such a way that the address 110 changes automatically when the location of the electronic data moves so as to maintain an accurate register of data locations for the sake of retrieving the information for use by the researcher. In some embodiments, the address of the data record returned to the user in response to a query of the database provides a link to the location of the data record, which allows the user to access the information immediately by selecting the address.

The database also contains metadata terms that are associated with data records 115. Each unique data record is associated with any number of metadata terms 115 that describe the information in the data record. Metadata terms 115 are selected from a controlled vocabulary 125 in which each metadata term 115 is defined in a manner useful in characterizing the information in the underlying data record in an unambiguous manner.

The metadata terms 115 are contained in the secondary metadata database 120 which includes the controlled vocabulary of metadata terms in hierarchical relationships to one another 125 along with other lists of terms (“thesauri”) 130 which are related to the metadata terms 115 as equivalent terms and for which one or more metadata terms 115 may be substituted during a search.

In some embodiments, metadata terms 115 describe the bibliographic characteristics of the document as a whole, including standardized descriptions of documents and document properties (e.g. Dublin Core Metadata Initiative Metadata Terms) such as title, creator, subject, description, publisher, contributor, date, type, format, identifier, source, language, relation, coverage and rights. In some embodiments of, metadata terms 115 refer to the content of the information, including descriptions of its subject matter, location, range of dates covered and species discussed.

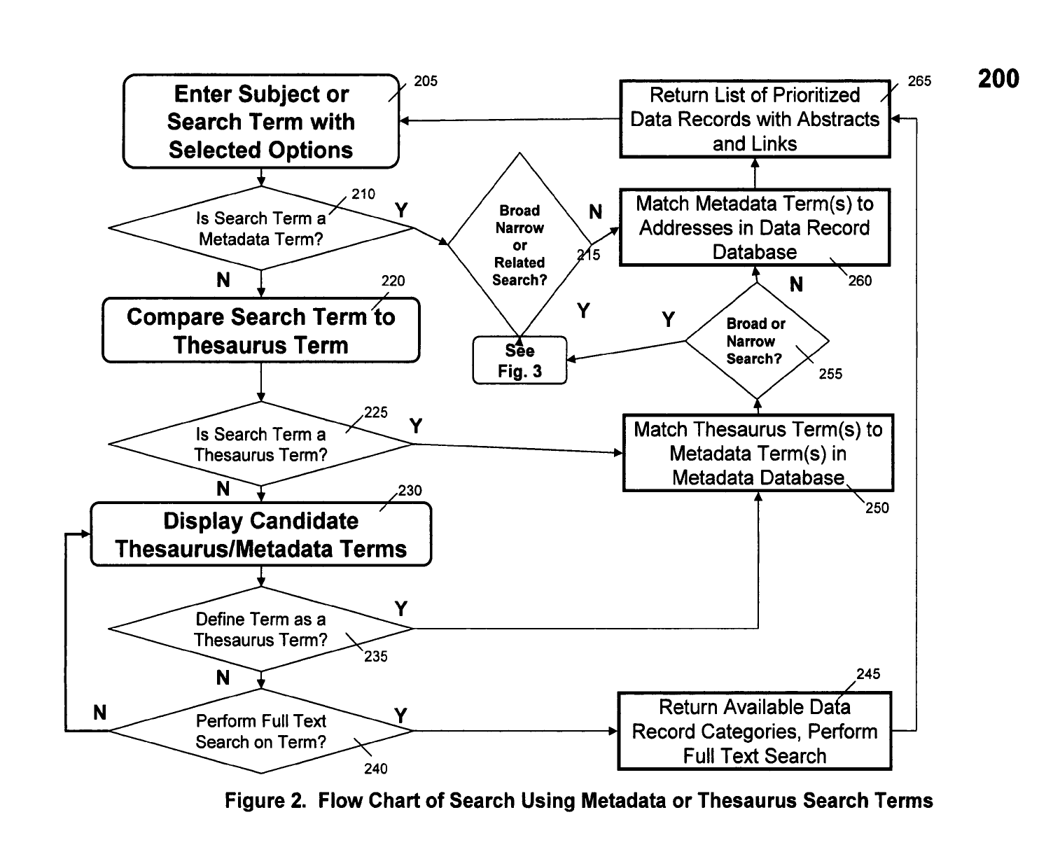

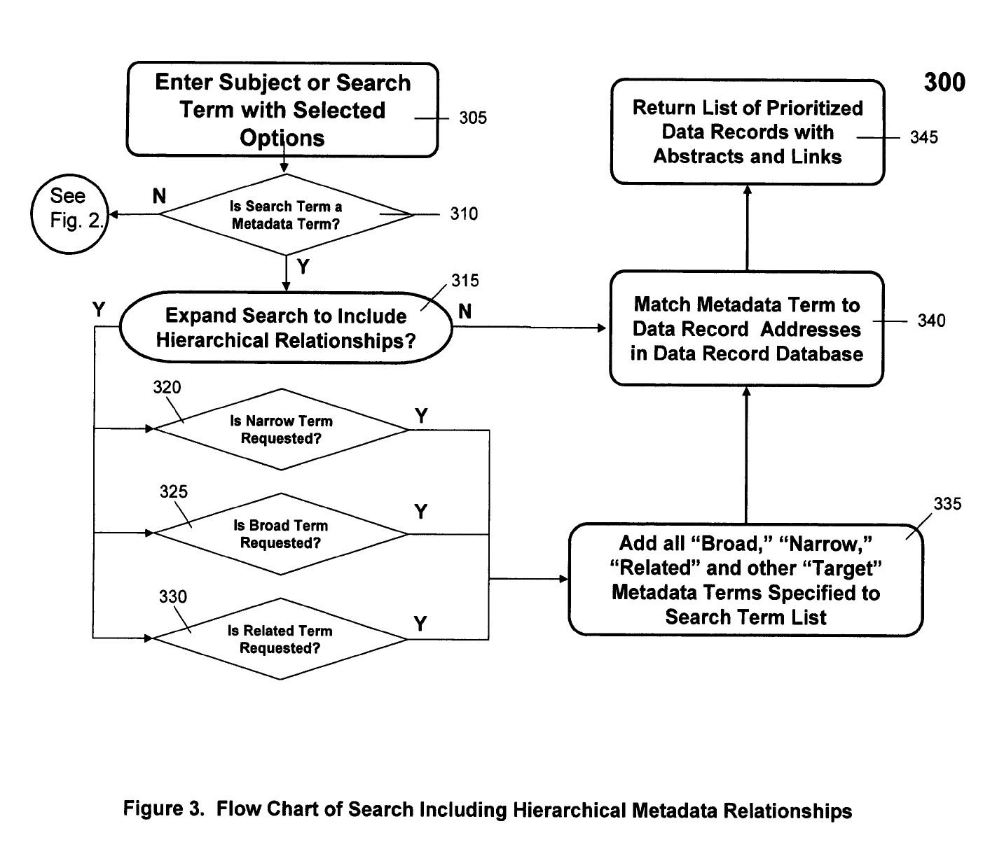

FIG. 2 shows a manner of operating a data processing system to allow a user to use the primary data record database 105 and the secondary metadata database 120 to search for information. In some embodiments, a user enters to the data processing system a search term in step 205 along with various search parameters. Initially, the data processing system receives a request for environmental information including the search term in the form of at least a keyword, value or other indicator that relates an electronic thesaurus to metadata. The data processing system compares the search term to a list of metadata terms 115 in the metadata database 120. If a match is found in step 210, the user is given the option in step 215 of broadening the search to include hierarchically related terms, as explained further in FIG. 3. If a broader search is not desired, the data processing system compares the matched term to the metadata terms 115 associated with data records in the data record database 105 in step 260. Accordingly, the data processing system may return the corresponding matched record addresses 110 to the user with information about the available documents matching the greatest number or most heavily weighted terms in step 265.

If the search term entered by the user does not match any of the metadata terms 115 in the controlled vocabulary 125 in step 210, the search term is compared to a list of terms in other thesauri 130 in step 220 whose equivalence to the metadata 115 is listed in the metadata database 120. If a match is found in step 225, the matched thesaurus term is compared to the associated metadata terms in step 250, at which point the user is given the option in step 255 of broadening the search to include hierarchically related terms, as explained further in FIG. 3. If a broader search is not desired, the metadata terms are matched with the data records in the data record database 105 in step 260. As before, the matched records are returned to the user with information about the available documents matching the greatest number or most heavily weighted terms in step 265.

If the search term entered by the user does not match any of the other thesaurus terms in the metadata database 120, the user is offered the option of selecting an appropriate term to which the unknown search term may be associated in step 230. When the user selects an appropriate thesaurus term in step 235, the term is matched with its related metadata term 250, at which point the user is given the option in step 255 of broadening the search to include hierarchically related terms, as explained further in FIG. 3. If a broader search is not desired, the metadata terms are matched with the data records in the data record database 105 in step 260. As before, the matched records are returned to the user with information about available documents matching the greatest number or most heavily weighted terms in step 265.

If the user does not recognize any terms from the metadata database 120 as similar in significance to the unknown search term, the user may choose to perform a full text search with the search terms in step 240, at which point the unknown search term or terms will be compared to the readable text in the title and content of all documents in the data record database in step 245. Information about documents containing this search term will then be returned as search results to the user in step 265.

As shown in FIG. 3, in some embodiments, a data processing system is used so that the user may choose to broaden the search to include metadata terms hierarchically related to the metadata 115 associated with the search term. In step 305, a user enters a search term along with various search parameters. If the search term is not a metadata term in step 310, please refer to FIG. 2, however if the search term is a metadata term, proceed to step 315. In step 315 the user has the option to expand the search to include hierarchically related metadata terms. When a user selects this option in step 315, the metadata terms in the metadata database that are hierarchically related to the search term are reviewed, and those additional metadata terms having the appropriate relationship specified by the user in steps 320 through 330, narrow, broad, and related terms respectively, are added to the search terms in step 335, which are in turn compared with the metadata terms 115 in the data record database 105 in step 340.

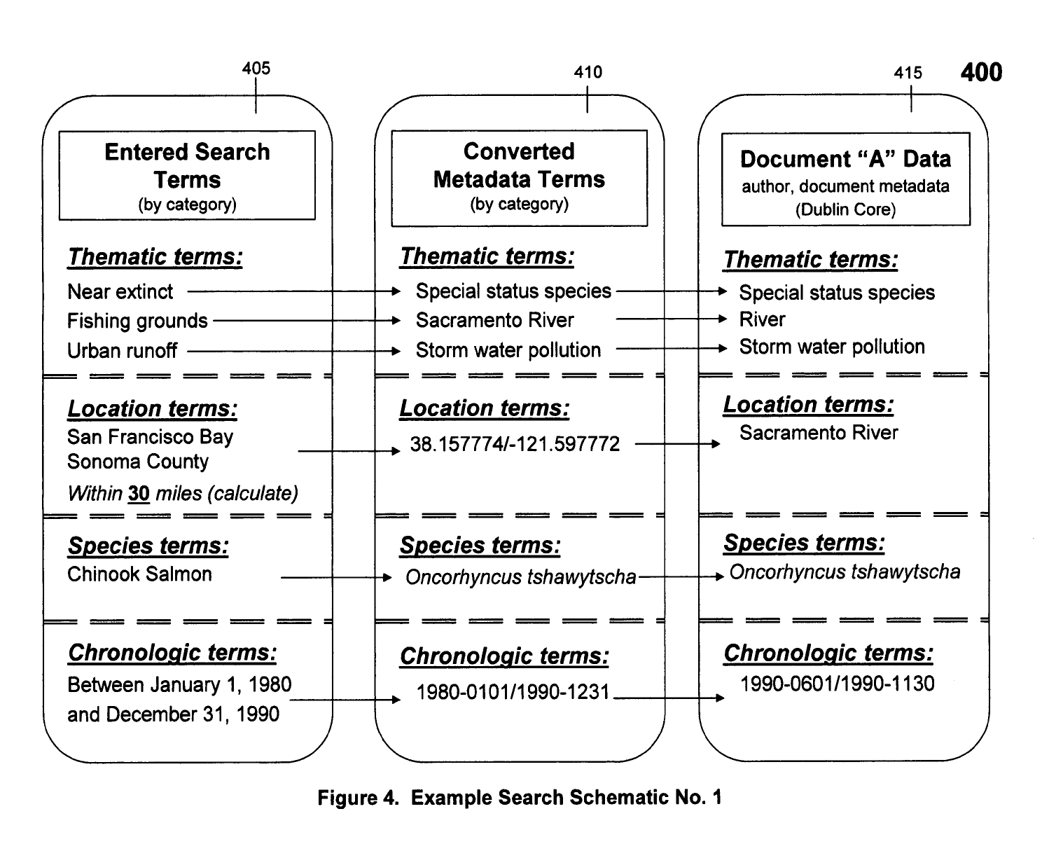

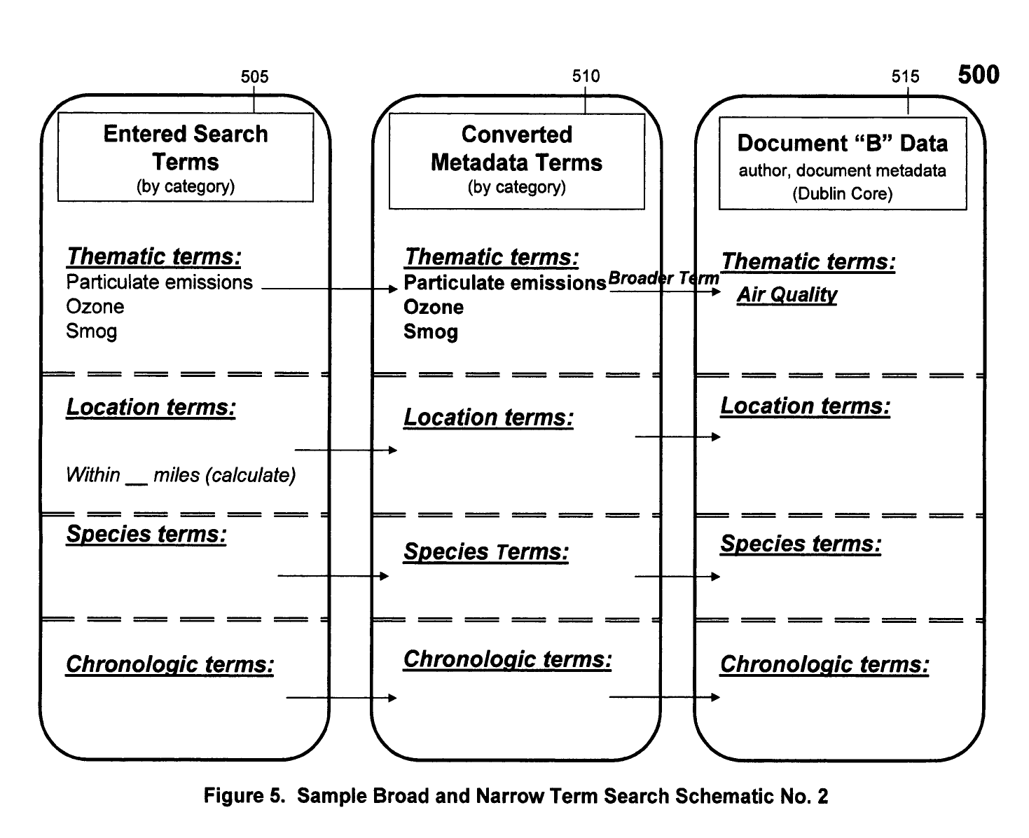

Detailed examples of how the system and method described in FIGS. 2 and 3 might be implemented are illustrated in FIGS. 4 through 6. FIG. 4 shows how a user query for information can be translated by a data processing system into controlled metadata terms and yield documents from the primary database 105. In this example, the user searches for particular documents about the impact of water pollution on a type of salmon at stage 405 by entering the general search terms “Chinook salmon,” “near-extinct,” “fishing grounds,” “urban runoff,” in the user interface 140, none of which are metadata terms used to index documents directly. The search further specifies information concerning a period between 1980 and 1990 for a location within “30 miles of San Francisco Bay.” These search terms are checked at stage 410 for equivalence with thesaurus terms and metadata terms in the metadata database 120 to yield the respective metadata terms “Oncorhynchus tshawytscha” for “Chinook salmon”; endangered species for “near extinct”; river for “fishing grounds”; storm water pollution for “urban runoff”; a chronological scalar 1980-0101/1990-1231 to signify the time period 1980 to 1990; and the geocodes 38.157774/−121.597772 with an appropriate mathematical parameter to define “within 30 miles of San Francisco Bay.” These metadata are then matched with the data records in the data record database 105 in stage 415 to locate a source of information (Document A) that has been characterized by metadata terms including document type, thematic terms, species, location, date, or other preselected or user defined metadata categories. FIG. 5 shows how a user query can be expanded by including a search for documents indexed with metadata terms that are hierarchically related to the initial search term by being broader or narrower than the initial term. In this example, in stage 505 the user's initial search for documents about air quality is expanded by including a search for documents indexed according to narrower metadata terms—in this instance the terms particulate emissions, ozone and smog in stage 510. These additional metadata terms are then matched with the data records in the data record database 105 at stage 515 such that the addresses of documents indexed according to either air quality, particulate emissions, ozone or smog will all be returned to the user. In some cases, the actual documents (electronic) or links to those documents will also be returned to the user.

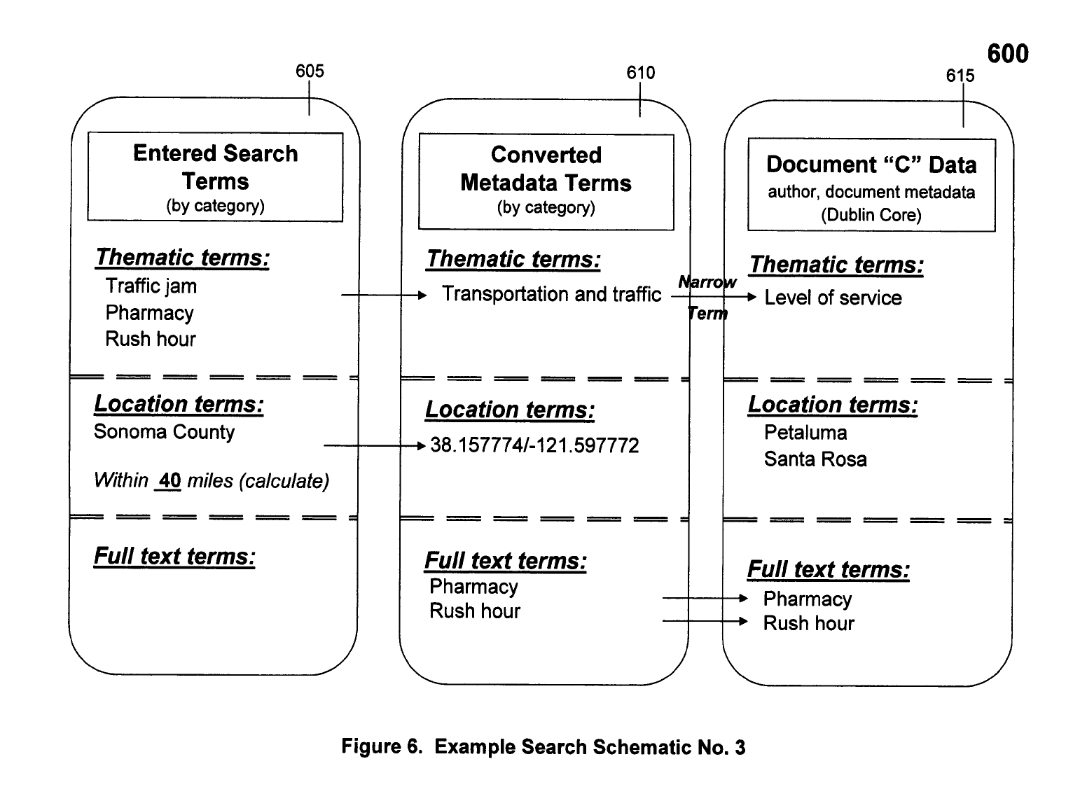

In some embodiments, the user can combine expanded searches of metadata terms with full text searches to find documents indexed according to the controlled metadata terms, which also include specific words including variant usages. In FIG. 6, at stage 605, a user interested in researching information about the environmental impact of constructing a retail development (including a pharmacy) on rush hour traffic searches for documents indexed according to the non-controlled terms “traffic jam,” “rush hour” and “pharmacy” with geographic parameters to narrow the search to a specific region 605. The user further specifies that narrower metadata terms should be included in the search, and that terms with no metadata equivalents may be used to search the full text of available documents. As in the earlier example in stage 610, the term “traffic jam” is translated to the controlled metadata term transportation and traffic along with narrower terms, which include level of service 610, an indication of congestion. In addition, the terms “rush hour” and “pharmacy” are used to search the text of available documents. A document matching these requirements, indexed according to the metadata term level of service and containing the terms “rush hour” and “pharmacy” in the text is returned to the user in stage 615.

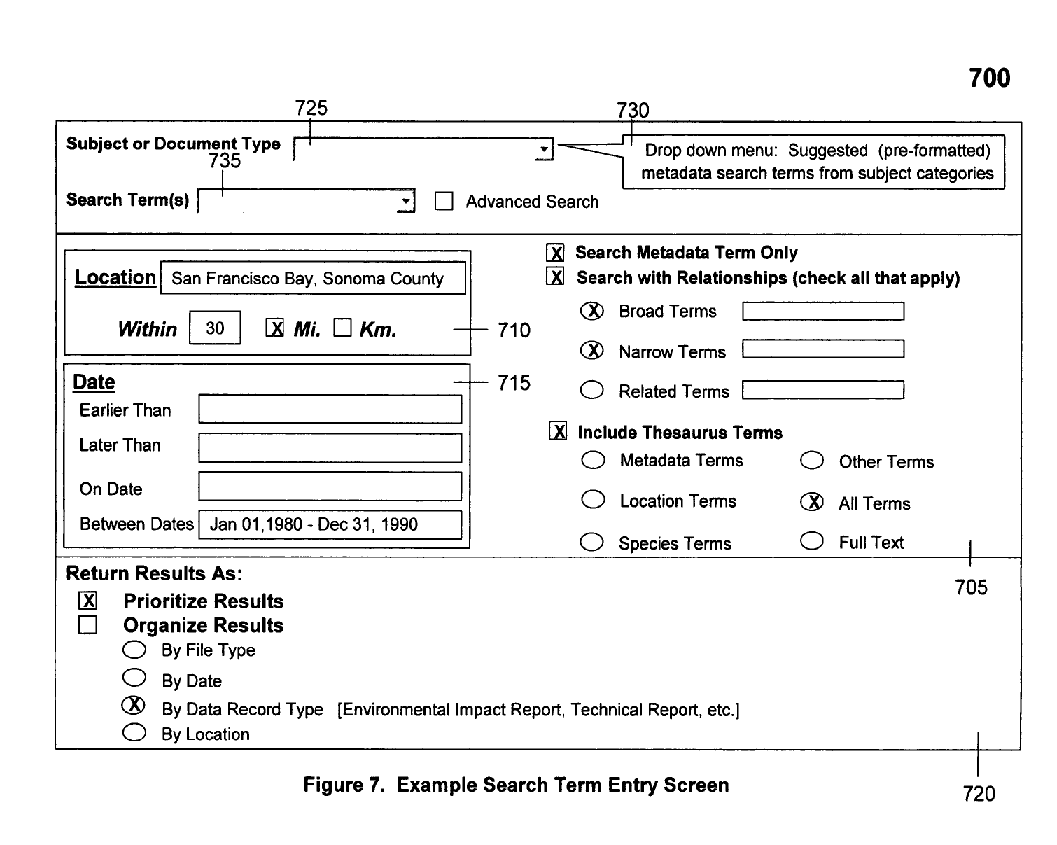

FIG. 7 shows an example screen of the type in which the user can enter various search terms and other parameters concerning the desired information (e.g. location and date of data). In some embodiments, the user interface 140 includes a series of displayed text boxes in which the user enters various types of search information, organized by category. When the user enters one or more terms describing the type of document sought or the type or subject of the environmental information in box 725, a menu of candidate search metadata search terms is provided in box 730. When the user selects one or more of the candidate metadata terms by highlighting and clicking on the candidate term that metadata term is automatically added to the search terms in box 735. A user can also specify a location and range in box 710 and a date range in box 715. Searching with metadata and/or thesaurus terms can be selected in box 705 and the results can be prioritized or organized according to user input in box 720.

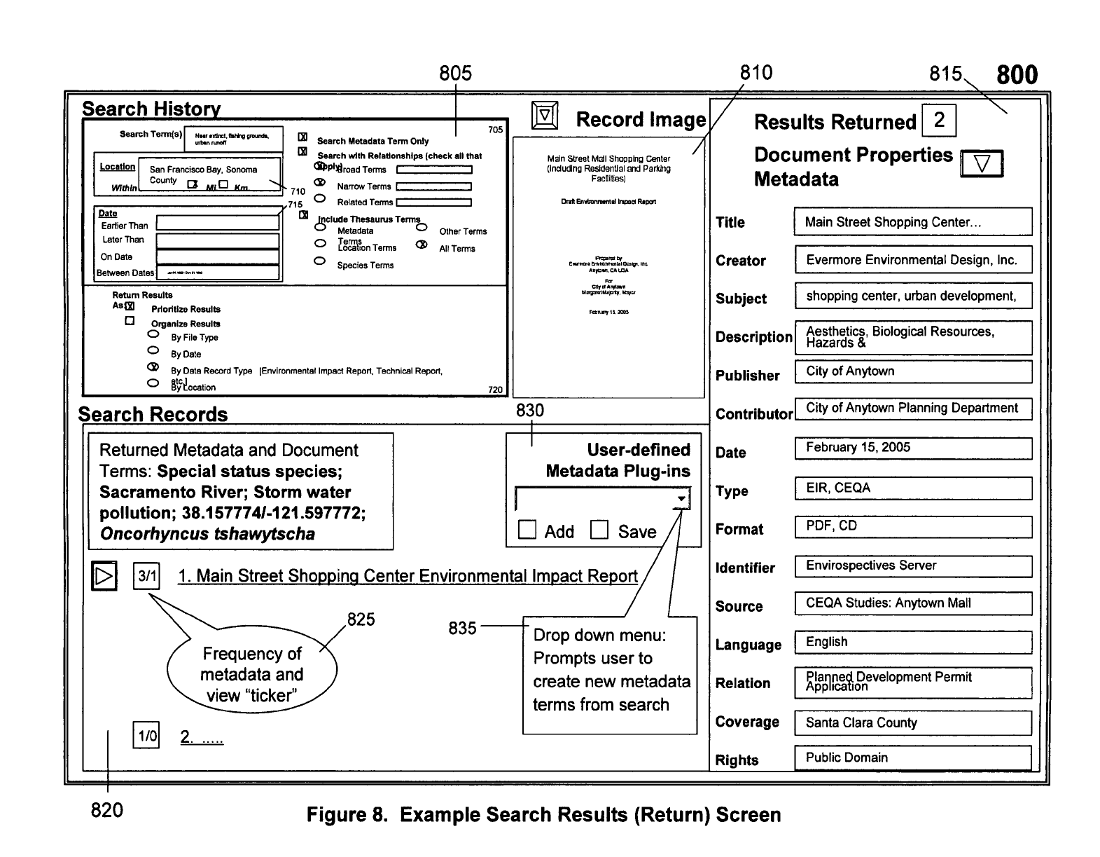

FIG. 8 shows an example screen, of the type in which the user would receive the desired information about returned documents. Such a display may be facilitated by a user computer, which is implemented in, for example, the hardware shown at FIG. 17, below. The search history section 805 shows the search parameters used, including location information 710 of FIG. 7 and date parameters 715 also of FIG. 7. A search history is search parameters used, including location information and date parameters. The order in which results are specified to be returned are shown in box 820, while the data records associated in database 105 are listed in box 830 along with the number of times a specific metadata term 115 of FIG. 1 matches the returned document 825. The first page of the first or selected record image is shown in section 810, along with a description of the first or selected identified document according to Dublin core or other appropriate document metadata shown in section 815. In some embodiments, the list of data records is prioritized according to the number of search terms associated with the records. In some alternative embodiments, the list of data records is prioritized according to a number of instances of modifiers associated with the metadata indicating the degree of importance of an associated metadata term to the content of the data record. In a further embodiment, the list of data records includes an abstract summarizing each data record. In some alternative embodiments, each data record in the list is linked to the location on the network indicated by its address such that selecting an electronic data record automatically brings the data record to the user's computer.

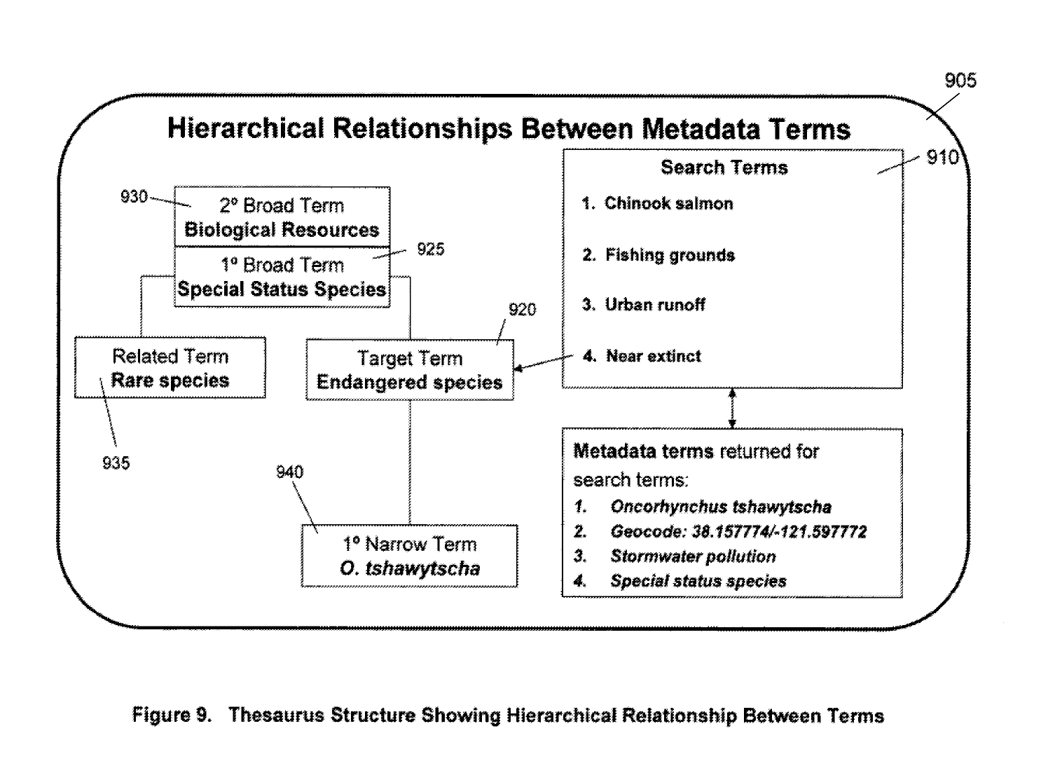

Illustrative embodiments allow the user to define a thesaurus term from an external vocabulary as equivalent to a metadata term from the controlled vocabulary by selecting it from a list of terms displayed on the computer and subsequently selecting the corresponding thesaurus term. As shown in FIG. 9, the non-standard term “near-extinct,” 910 may be considered as equivalent to the metadata term endangered species 920, which is a “narrow term” with respect to the metadata term special status species 925. As such, an expanded search on endangered species specified for “broad terms” will include all documents indexed under either endangered species or special status species 915. As further shown in the relationships included in 905, the term special status species is also a broad term with respect to the metadata terms rare species 935 and Oncorhynchus tshawytscha 940, and is itself a narrow term with respect to the broader term biological resources 930.

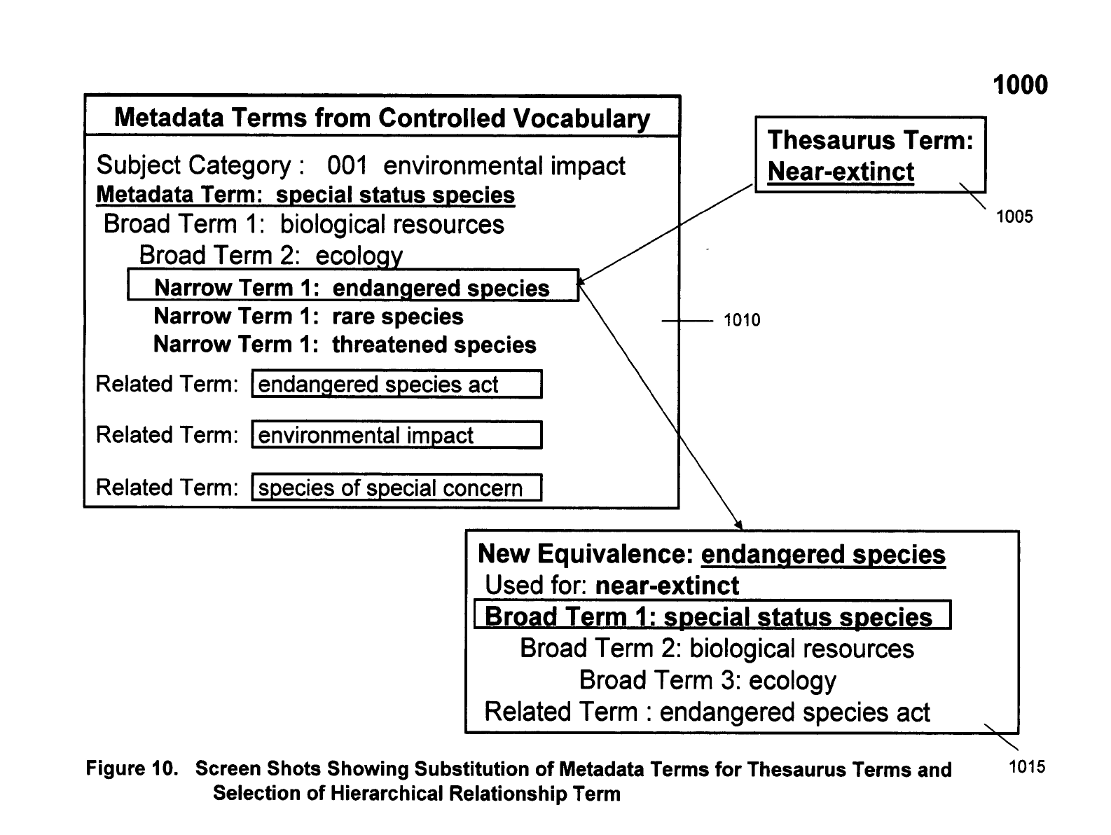

The reviewer is able to relate at thesaurus term to a metadata term through an appropriate screen as shown in FIG. 10. For example, by selecting the non-standard term “near-extinct” in box 1005 and dragging a cursor to extend an arrow to the metadata term endangered species in box 1010, the reviewer can establish an equivalence relationship between the two terms, which is illustrated with other hierarchical relationships in Box 1015.

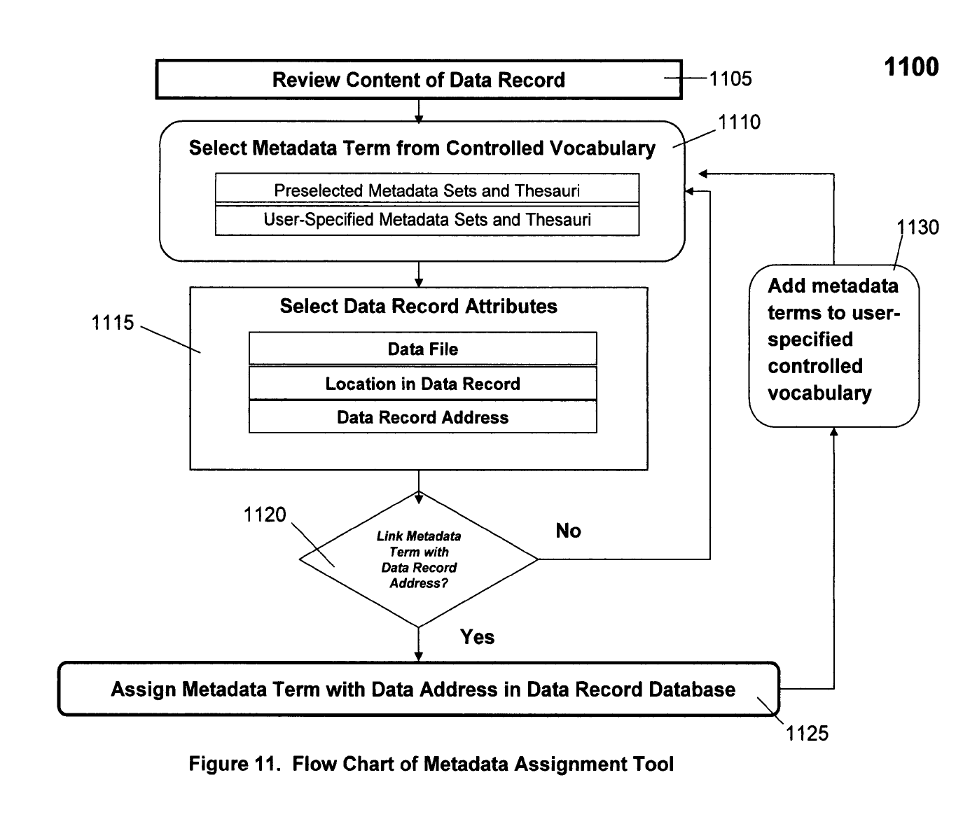

Embodiments of the invention allow reviewers to assign metadata to a data record to facilitate future access. As illustrated in FIG. 11, a reviewer analyzes the target document in step 1105 and selects a list of appropriate metadata terms to characterize its content in step 1110, including but not limited to thematic terms as wells as location, date and species referenced in the document. The reviewer then determines the appropriate document attributes to characterize the document, including its unique, unambiguous address in step 1115, and selects appropriate metadata terms to characterize the content of the document from controlled a vocabulary in step 1110. The reviewer then links the metadata with the data record address in the data record database in step 1120. The linked information is thereupon entered at step 1125 into the data record database 105, or else the reviewer returns to the metadata list at step 1110 to determine more appropriate metadata links. In the event that no appropriate metadata are found, a new metadata term may be associated with the data record and entered into the controlled vocabulary at step 1130.

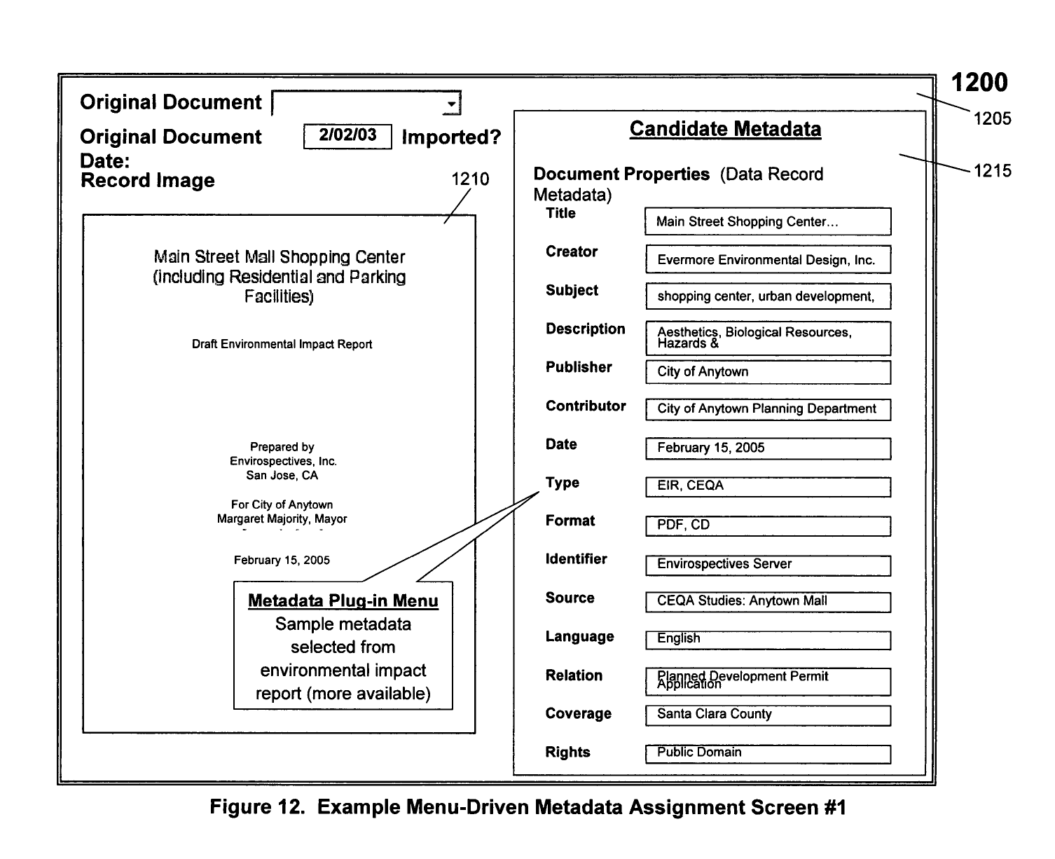

In some embodiments, all or part of an electronic record is displayed on a computer screen with one or more text boxes for entry of metadata. FIG. 12 illustrates an example screen 1205, in which a document title page is displayed 1210 adjacent to a selection of boxes for entering metadata pertinent to the entire document (e.g. Dublin Core metadata) 1215. The user enters the metadata in the appropriate text box, or selects from a dropdown menu of metadata terms, which are automatically entered in the textboxes. When the metadata entry for a given record is complete, the data record address is automatically entered in the database (with additional user-guided instructions) associated with the selected metadata.

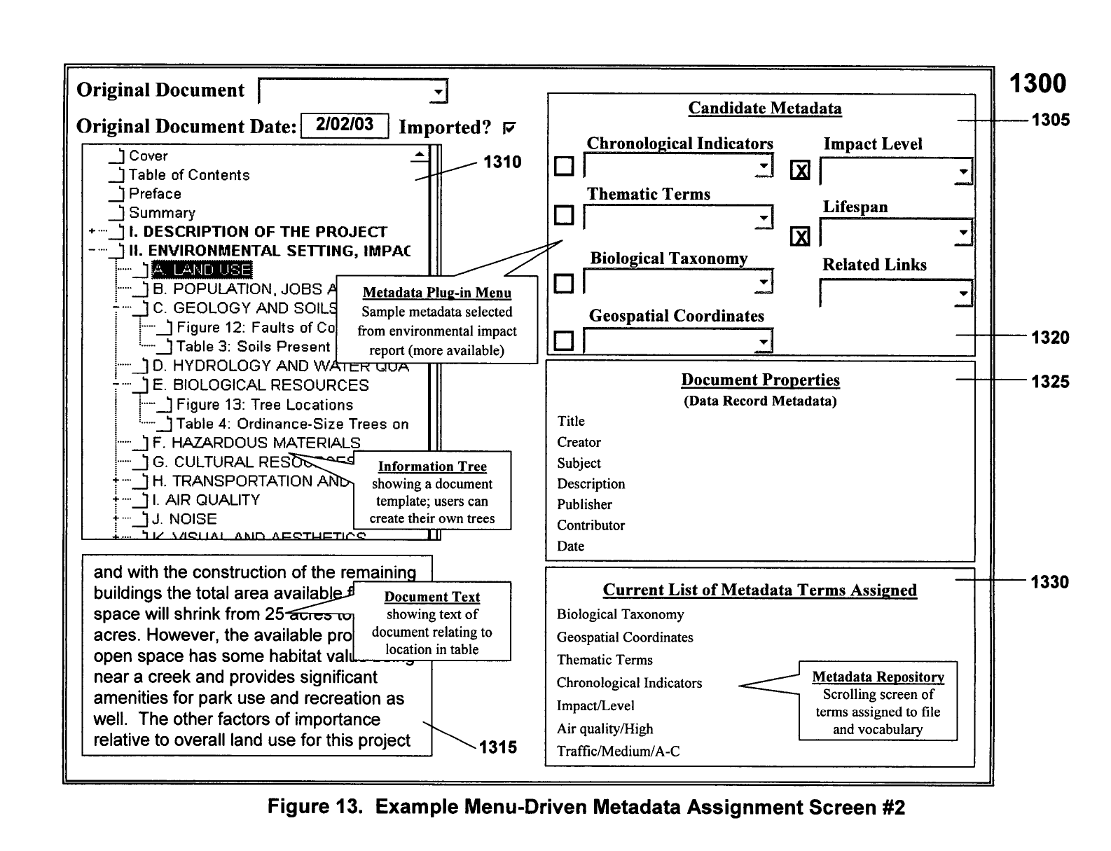

In some alternative embodiments, a similar procedure is provided for entering various types of metadata specific to different locations within the document. As illustrated in FIG. 13, the example screen 1305 includes an information tree, table of contents, bookmarks, or similar method for navigating an electronic document 1310. Selection of location within this navigation screen brings up corresponding text from within the document 1315. The example screen simultaneously displays various categories of example metadata terms 1320 which can be selected through a series of dropdown menus; in addition, the user may enter other metadata terms directly in the “Current List of Assigned Metadata Terms” 1330. Another portion of the example screen displays the common document metadata entered earlier as shown in FIG. 12 as document properties 1325. When the user hits the return key, both the data record address and the metadata terms listed in box 1330 are associated together and entered in the metadata database 105.

In a further embodiment, the user enters a description of the subject document, or a description of the type of environmental information contained in it, and a menu of candidate metadata terms or values to characterize the document is provided. The user can then select one or more candidate terms to associate with the document address (refer to FIG. 7).

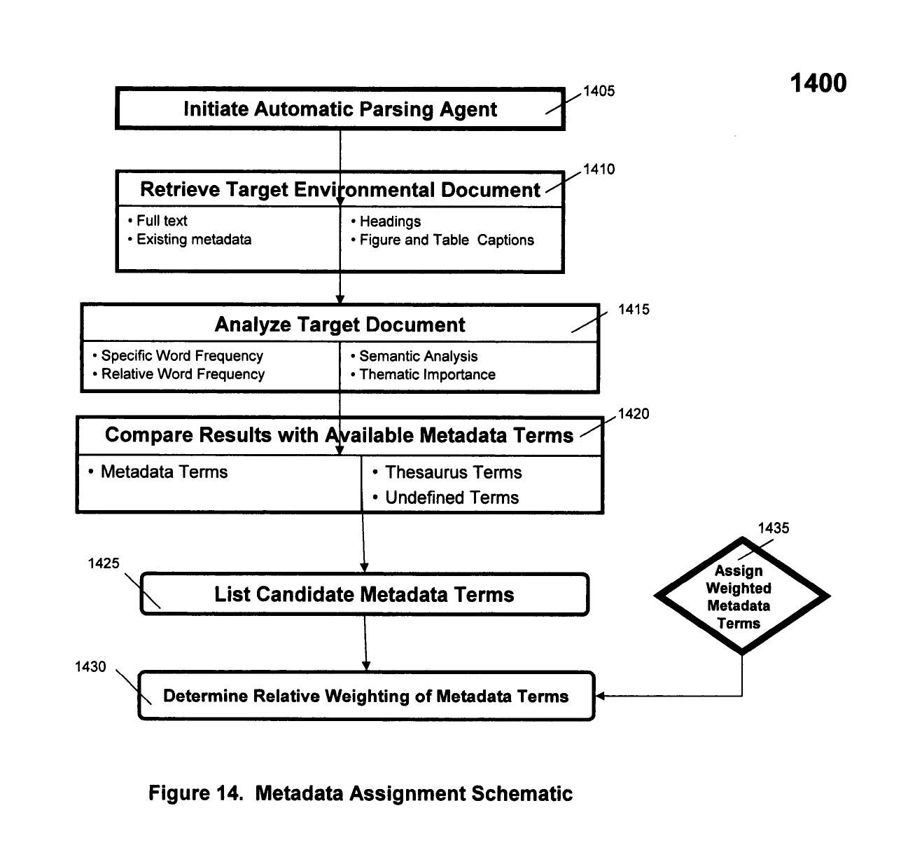

FIG. 14 illustrates some alternative embodiments in which the assignment of metadata is accomplished automatically by means of an automatic parsing agent 1400. By initiating the parsing agent 1405 the reviewer allows the agent to retrieve the target document 1410 and analyze it for metadata terms and other significant words 1415 according to their frequency and use in headings and elsewhere. These words are then compared against a list of available metadata terms 1420, and based on the results of the target document evaluation, a list of candidate terms is offered for assignment to the document 1425. The candidate terms are weighted according to the frequency of their occurrence 1435 and usage or according to some other predetermined standard 1430, and selected terms are then approved for use with the documents and associated with the data record address of the target document in the data record database 1435. Appropriate addresses may consist of its location in an electronic file, or a specific element within the file, or the physical location of a non-electronic data record. In a further embodiment, metadata terms are assigned automatically to the data records based on the frequency with which the metadata terms or the thesaurus equivalents occur within the metadata record.

In a further embodiment, document analysis consists of evaluating the text of the document for available terms, or by identifying the presence of available terms in the title and headings or by other means to determine its significance for the purpose of assigning appropriate metadata terms to characterize the document.

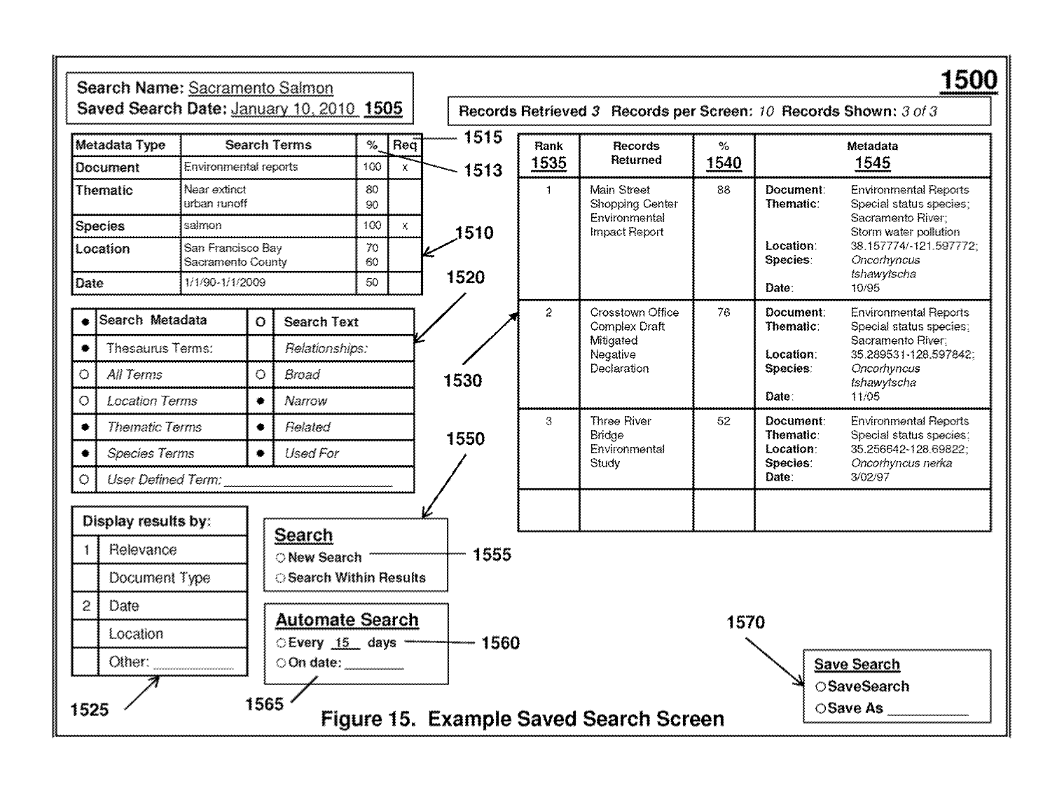

In a further embodiment, FIG. 15 is an example saved search screen displaying the parameters of a previously performed and retained or stored search that permits the user to retrieve results of a search for the desired information. FIG. 15 includes a summary of the results of the search. Screen 1500 shows the date the search was last performed 1505 along with a search name (if the user selected one). The search parameters entered to perform the search 700 depicted in FIG. 7 are displayed to search parameter table 1510, including document metadata, thematic terms, species, location information, and date parameters. The search history also may include a column of numbers for weighting search terms 1513 if selected by the user. A user-assigned weighting of “1” to “100” may be used to provide an indication of the relative relevance of the returned results based on the extent to which they match each individual search term. A total possible score is the sum of all metadata terms used in the search together with all text terms used in the search, if any. The data processing system calculates the total possible score by applying a full 100% weight to each metadata term or text term. The total possible form is used as a denominator in the next calculation. In some embodiments, the relative relevance of each data record returned 1540 is calculated by assigning a score equal to the user-assigned weighting for each instance in which the returned data record contains metadata matching the search term (or in the case of text searches, for each instance in which the returned data record contains the text term matching the search term) and the cumulative score is divided by the total possible score to calculate the “percent relevance” of the returned data record.

In a further embodiment, a user mark indicating that a search term is “required” 1515 is interpreted such that only data records associated in database 105 with metadata corresponding to a selected search term (or data with text containing the selected search term if this option is selected) is received.

In another embodiment, the displayed search results show additional information. As a first example, the displayed search results can show whether the search terms were compared to metadata associated with the records. In a second example, the displayed search results can show whether the search terms were compared to words in the text of the records. As a third example, the displayed search results can show the information of the first two examples, as well as show those search terms derived from the thesaurus 1520, including the extent to which the search results relied on broad terms, narrow terms, related terms or terms used for other terms. In an illustrative example, the user-entered search terms “near extinct” and “urban runoff”, shown in table 1510, relate to additional metadata terms according to the relationships “narrow”, “used for”, and “related to” as further described in FIGS. 4, 5, 6, and 10. In a further illustration, the user-entered search term “salmon” is related to the scientific metadata term “onchorhyncus” as described in relation to FIGS. 9 and 10.

In a further embodiment, the order in which results are returned is shown in box 1525. The data records associated in database 105, of FIG. 1, and received by a user computer, appear in the specified order 1530. In an embodiment, each result is displayed in order of its relative relevance 1540 (explained above) and assigned a ranking 1535 corresponding with the scalar indication of its relative relevance as compared to the other data records returned. In some embodiments, the metadata 1545 or text corresponding to the search terms is shown for each item of data displayed in the retrieved search results.

In some embodiments, the user can execute a new search 1550. In some embodiments the user can execute a new search of all available data records with the existing search parameter in table 1510 by selecting “new search” 1555. In some embodiments, the user can execute a new search of all available data records with new or revised search parameters by entering one or more new parameters or by modifying one or more of the existing search parameter in table 1510 and selecting “new search” 1555. New search parameters can be modified search terms. In other words, an existing parameter, such as, for example, a date, may become a modified search term in response to a user entering a date a week after the date previously entered and used for a search. In a further embodiment, the user may save the new search for future reference 1570 in place of the original search by assigning the same name to the saved search, or the user may save the new search in addition to the original search by assigning a different name to the saved search. Accordingly, a data processing system can allow a user to select new search parameters and the received records to be further retained or stored as a saved search associated with a user-defined name.

In an illustrative embodiment, the user may schedule the data processing system to re-execute a retained search on a schedule, for example, specifying a number of days 1560 or on a specified date 1565. The data processing system may notify the user in response to obtaining results. A retained search is a retained list of available data records received as a result of using search terms to search within initially available data records. Accordingly, the received environmental information is the available data records received as the result of a data processing system using the retained search to search any available data records.

In a further embodiment, the user can enter one or more new parameters or modify one or more of the existing search parameter in table 1510 enter new parameters and cause the data processing system to execute a new search within the results returned by selecting a search-within-results button 1555. A constrained search is the application of search parameters to search results returned by a previous search. In other words, a constrained search is a request received at a data processing system to further narrow or prioritize search results based on use of parameters, for example, search parameter table 1510.

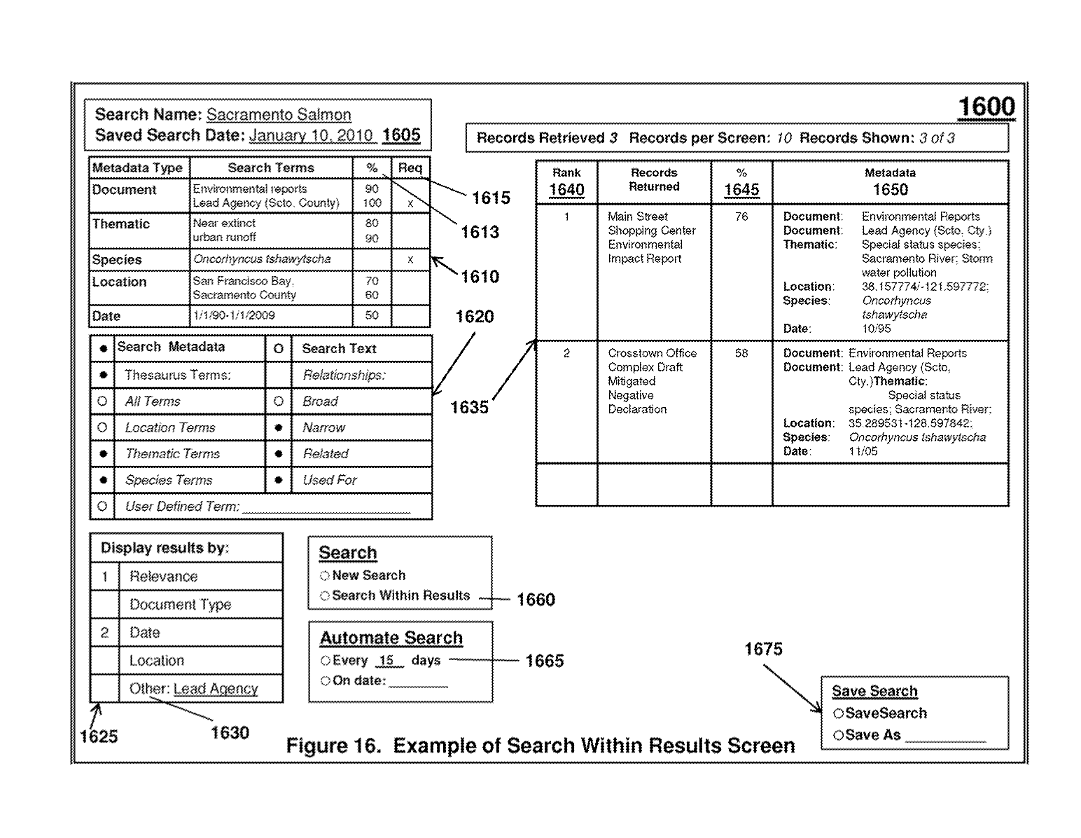

In a further embodiment, FIG. 16 shows an example screen of the type in which the user receives the results of a search within the results received from a prior search. Accordingly, secondary results screen 1600 shows a set of results generated after at least two screens of a database have been performed. A secondary result is the output or product of the data processing system applying new parameters to search results to produce a second set of search results. In this embodiment, the data records of in database 105 are received by a data processing system. A secondary result can include, for example, results that follow iterations of searching within progressively narrow search results. Accordingly, the term “secondary result” is not limited only to a second search result generated from a first search result. The data processing system reevaluates such data records for their correspondence to revised search terms. The data processing system modifies the search parameters of the previous search displayed in table 1610 responsive to user input. Table 1610, presents the parameters used in the previous search, among other data. In some embodiments, the search parameters are modified by receiving user input to provide new information in the table 1610. In another embodiment, the search parameters are modified by receiving user input of new information in the original search term screen 700 of FIG. 7.

In some embodiments, the data processing system weights the search parameters of table 1610 by associating each group of search parameters with a corresponding user-defined relevance weight 1613. A user-assigned weighting of “1” to “100” may be used to provide an indication of the relative relevance of the returned results based on the extent to which they match each individual search term. The relative relevance of each data record returned 1645 can be calculated by assigning a score equal to the user-assigned weighting for each instance in which the returned data record contains metadata matching the search term (or in the case of text searches, for each instance in which the returned data record contains the text term matching the search term) and the cumulative score is divided by the total possible score to calculate the “percent relevance” of the returned data record.

In a further embodiment, a user mark indicating that a search term is “required” 1615 is interpreted such that only data records associated in database 105 with metadata corresponding to a selected search term (or data with text containing the selected search term if this option is selected) is received. In an illustrative embodiment, the search terms in the previous search were modified to specify that the data records, to be returned from among the previous data records returned, are only those data records associated with metadata such that the document metadata term “Lead Agency” is associated with “Sacramento County” and the species metadata term is associated with the species “Oncorhyncus tshawytscha.”

In a further embodiment, the displayed search results show additional information. As a first example 1620, the displayed search results can show whether the search terms were compared to metadata associated with the records. In a second example, the displayed search results can show whether the search terms were compared to words in the text of the records. As a third example, the displayed search results can show the information of the first two examples, as well as show those search terms derived from the thesaurus, including the extent to which the search results relied on broad terms, narrow terms, related terms or terms used for other terms. In an illustrative example, the user-entered search terms “near extinct” and “urban runoff” shown in table 1610 were related to additional metadata terms according to the relationships “narrow” “used for” and “related to” as described in above and further described in FIGS. 4, 5, 6, and 10. In a further illustration, the user-entered search term “salmon” was related to the scientific metadata term “onchorhyncus” as described in relation to FIG. 9 above.

In a further embodiment, the data processing system is configured to receive options from the user. The user may indicate that a secondary search is to take place. For example, the user can select “new search” 1665 in order to re-execute the search on all available data with the search terms entered at the time of the selection. Alternatively, the user may select “search within results” 1660. Accordingly, in response to such a user selection, the data processing system may return results of a user-entered “search within results” command. In response to performing a search based solely on primary results, the data processing system may organize secondary results in an order as specified by the user 1625 according to pre-selected categories or user-selected terms 1630. Secondary results are results generated by the data processing system based on a primary search applied to a database, whereby such results are further searched to generate a still-narrower set of results.

In a further embodiment, the user selects the order in which results are returned in box 1625. Based on the user inputs, the data records associated in database 105, of FIG. 1, and received by a user computer, appear in the specified order 1635. In an embodiment, each result is displayed in order of its relative relevance 1645 as defined above and assigned a ranking 1640 corresponding with the scalar indication of its relative relevance as compared to the other data records returned. In some embodiments, the metadata 1650 or text corresponding to the search terms is shown for each item of data displayed in the retrieved search results.

The number of records displayed in table 1635, corresponding to the search parameters shown in table 1610 of FIG. 16, is smaller than the number of records displayed in Table 1530 corresponding to the search parameters of the retained search in table 1510 of FIG. 15. The retained search may be stored to hard disk drive 1726 or the like with the same name 1605 or with a new name. A new search is a combination of parameters describing a prototype search that has not been used to guide execution of a search on a data processing system. The change in number of records indicates that the secondary results of the retained search displayed in FIG. 15 further refines the search process resulting in fewer received records that correspond to the refined search parameters shown in FIG. 16. Table 1610 shows that a new search term has been added to the “Document” search terms. The new search term may be used by the data processing system to locate data records within the primary results. In this case, document metadata corresponds to “Lead Agency=Sacramento County.” In addition, the parameter for the “Species” search term has been revised to locate data records within the primary results, which are associated with species metadata including the term “Oncorhyncus tshawytscha.” In addition, an indication of “required” has been assigned to that metadata term such that data records whose metadata that fails to correspond to that term will not be returned.

In a further embodiment of the invention, the user can program the computer to execute a new search with the search terms periodically or on a date and to notify the user when the results have been obtained. For example, a user may enter a recurring period in date field 1665 so that the data processing system receives a command to re-execute the retained search.

In another embodiment, the data processing system retains a list of data records received as secondary results. Secondary results are explained further above. Accordingly, the data processing system may retain or store secondary results for future reference and use. In a further embodiment, the retained list is associated with a user-defined name 1675.

Illustrative embodiments of the invention provide a method, apparatus and computer program product for dispatching workloads to servers, and optionally adjusting processor voltages and frequencies based on resource requirements including power constraints, among others. The data processing device may be a stand-alone computing device, a cluster of computing devices operating as a single system or a distributed data processing system in which multiple computing devices are utilized to perform various aspects of the illustrative embodiments. Therefore, the following FIG. 17 is provided as exemplary diagrams of data processing environments in which the invention may be implemented. FIG. 17 is only exemplary and is not intended to assert or imply any limitation with regard to the environments in which the invention may be implemented. Many modifications to the depicted environments may be made without departing from the spirit and scope of the invention.

With reference now to the figures and in particular with reference to FIG. 17, a block diagram of a data processing system is shown in which aspects of an illustrative embodiment may be implemented. Data processing system 1700 is an example of a computer, in which code or instructions implementing the processes of the present invention may be located. In the depicted example, data processing system 1700 employs a hub architecture including a north bridge and memory controller hub (NB/MCH) 1702 and a south bridge and input/output (I/O) controller hub (SB/ICH) 1704. Processor 1706, main memory 1708, and graphics processor 1710 connect to north bridge and memory controller hub 1702. Graphics processor 1710 may connect to the NB/MCH through an accelerated graphics port (AGP), for example.

In the depicted example, local area network (LAN) adapter 1712 connects to south bridge and I/O controller hub 1704 and audio adapter 1716, keyboard and mouse adapter 1720, modem 1722, read only memory (ROM) 1724, hard disk drive (HDD) 1726, CD-ROM drive 1730, universal serial bus (USB) ports and other communications ports 1732, and PCI/PCIe devices 1734 connect to south bridge and I/O controller hub 1704 through bus 1738 and bus 1740. PCI/PCIe devices may include, for example, Ethernet adapters, add-in cards, and PC cards for notebook computers. PCI uses a card bus controller, while PCIe does not. ROM 1724 may be, for example, a flash binary input/output system (BIOS). Hard disk drive 1726 and CD-ROM drive 1730 may use, for example, an integrated drive electronics (IDE) or serial advanced technology attachment (SATA) interface. A super I/O (SIO) device 1736 may be connected to south bridge and I/O controller hub 1704.

An operating system runs on processor 1706, and coordinates and provides control of various components within data processing system 1700 in FIG. 17. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 1700. Java™ is a trademark of Sun Microsystems, Inc. in the United States, other countries, or both.

Instructions for the operating system, the object-oriented programming system, and applications or programs are located on storage devices, such as hard disk drive 1726, and may be loaded into main memory 1708 for execution by processor 1706. The processes of the present invention can be performed by processor 1706 using computer implemented instructions, which may be located in a memory such as, for example, main memory 1708, read only memory 1724, or in one or more peripheral devices.

Those of ordinary skill in the art will appreciate that the hardware in FIG. 17 may vary depending on the implementation. Other internal hardware or peripheral devices, such as flash memory, equivalent non-volatile memory, and the like, may be used in addition to or in place of the hardware depicted in FIG. 17. In addition, the processes of the illustrative embodiments may be applied to a multiprocessor data processing system.

In some illustrative examples, data processing system 1700 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 1708 or a cache such as found in north bridge and memory controller hub 1702. A processing unit may include one or more processors or CPUs. The depicted example in FIG. 17 is not meant to imply architectural limitations. For example, data processing system 1700 also may be a tablet computer, laptop computer, or telephone device in addition to taking the form of a PDA.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A user computer may operate as a client to a server. The embodiments of the invention may operate within a user computer, or as a cooperation of data processing between the user computer and one or more servers, implemented, for example, as data processing system 1700.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A system for accessing environmental information from a user computer, comprising:
a) an environmental database, the environmental database containing addresses to environmental information related to:
an environment-modifying event, the environment-modifying event including an environment-modifying natural event or construction project (“project”);
a natural, constructed or socioeconomic feature in the area of the project (“setting”);
a change to the setting brought about by the project (“impact”); or
a feature designed to ameliorate a potential environmental impact of the project (“mitigation”);
b) a metadata database, the metadata database containing metadata associated with the addresses; and
c) a user interface, the user interface adapted to receive a search term from the user computer and applying the search term to the metadata database, wherein a controlled vocabulary contains terms of metadata and the terms of metadata are related to each other either hierarchically or incidentally, including such relationships as “narrow” or “related to”.

2. A system for accessing environmental information from a user computer, comprising:
an environmental database, the environmental database containing addresses to environmental information;
a metadata database, the metadata database containing metadata associated with the addresses, the metadata database containing a thesaurus, the thesaurus containing metadata terms arranged hierarchically; and
a user interface, the user interface adapted to receive a search term from the user computer and applying the search term to the metadata database, wherein the user interface transmits to the user computer a list of data records.

3. The system of claim 2 wherein the list of data records is prioritized according to a number of instances of correspondence to search terms each data record contains.

4. The system of claim 3 wherein the list of data records is prioritized according to a number of instances of modifiers associated with the metadata each data record contains.

5. The system of claim 3 wherein the user interface provides abstracts of the data records along with the list of data records.

6. The system of claim 3 wherein the user interface provides hyperlinks to some of the data records identified in the list of data records.

7. A system for accessing environmental information from a user computer, comprising:
an environmental database, the environmental database containing addresses to environmental information related to:
an environment-modifying event, the environment-modifying event including an environment-modifying natural event or construction project (“project”);
a natural, constructed or socioeconomic feature in the area of the project (“setting”);
a change to the setting brought about by the project (“impact”); or
a feature designed to ameliorate a potential environmental impact of the project (“mitigation”);
a metadata database, the metadata database containing metadata associated with the addresses; and
a user computer adapted to receive a search term from a data processing system and applying the search term to the metadata database, wherein a controlled vocabulary contains terms of metadata and an electronic thesaurus relates at least one metadata term to search terms, values or other indicators wherein the system is configured to receive a request for environmental information comprising a keyword, value or other indicator which relates the electronic thesaurus to metadata.

8. A computer implemented method for searching environmental information, comprising:
(a) receiving a search term for searching environmental information regarding a proposed environment-modifying project, including information about:
an environment-modifying natural event or construction project (“project”);
a natural, constructed or socioeconomic feature in the area of the project (“setting”);
a change to the setting brought about by the project (“impact”); or
a feature designed to ameliorate a potential environmental impact of the project (“mitigation”);
(b) relating the search term to a metadata term for searching the environmental information; and
(c) retrieving environmental information based on the metadata term.

9. The method of claim 8, further comprising: (d) prioritizing the environmental information.

10. The method of claim 8, further comprising: (e) transmitting the environmental information.

11. A computer implemented method for accessing environmental information, comprising:
(a) receiving first environmental information regarding a proposed environment-modifying project, including information about project information, setting information, impact information, or mitigation information, wherein project information comprises information about an environment-modifying natural event or construction project; wherein setting information comprises information about a natural, constructed or socioeconomic feature in the area of the project; wherein impact information comprises information about a change to the setting brought about by the project; and wherein mitigation information comprises information about a feature designed to ameliorate a potential environmental impact of the project;
(b) automatically associating at least some of the first environmental information within a source of information with metadata, including some interrelated project information, setting information, impact information, and mitigation information, wherein the metadata is selected from a controlled vocabulary or a user-defined vocabulary to characterize the first environmental information, at least some of terms of metadata existing in an electronic thesaurus, wherein the electronic thesaurus comprises equivalent terms;
(c) receiving a request from a computer for requested environmental information in the form of a search term, specific value or other user-specified indicator, the requested information being the first environmental information or any information associated with metadata or other information derived at least in part from the first environmental information;
(d) relating the search term, specific value or other user-specified indicator to the metadata in the electronic thesaurus to obtain sources of information corresponding to the requested environmental information;
(e) identifying the sources of information corresponding to the requested environmental information; and
(f) displaying a listing of a plurality of responsive sources of information indicators, with the order of sources of information indicators corresponding to a weighting of metadata terms associated with the sources of information.

12. The computer implemented method of claim 11, further comprising (g) retaining a search history, wherein the search history comprises at least one selected from a group consisting of location information and date parameters.

13. The computer implemented method of claim 11 wherein a search is associated with metadata about a search describing the number of pieces of information retrieved.

14. The computer implemented method of claim 11 wherein a search is associated with metadata describing a relevance of information retrieved.

15. The computer implemented method of claim 11 wherein a search is associated with metadata, wherein the metadata describes the degree to which search terms are related to one or more thesaurus terms.

16. The computer implemented method of claim 11 wherein a search is associated with metadata, wherein the metadata describes one or more user-defined metadata terms.

17. The computer implemented method of claim 11 further comprising:
(g) responsive to identifying the sources of information, searching the sources of information to form received environmental information;
(h) retrieving a retained search with the received environmental information and associated metadata; and
(i) re-executing the retained search.

18. The computer implemented method of claim 11 further comprising:
(g) responsive to identifying the sources of information, searching the sources of information to form received environmental information;
(h) retrieving a retained search with the received environmental information and associated metadata; and
(i) modifying one or more of the search terms and re-execution of the retained search.

19. The computer implemented method of claim 11 further comprising:
(g) responsive to identifying the sources of information, searching the sources of information to form received environmental information;
(h) retrieving a retained search with the received environmental information and associated metadata; and
(i) modifying one or more of the search terms and re-execution of the retained search within the retrieved results.

20. The computer implemented method of claim 11 further comprising:
(g) responsive to identifying the sources of information, searching the sources of information to form received environmental information;
(h) retrieving a retained search with the received environmental information and associated metadata; and
(i) executing a new search with modified search terms.
